(19) United States
(12) Patent Application Publication
(10) Pub. No.: US 2025/0069299 A1
(43) Pub. Date: Feb. 27, 2025

(54) IMAGE RELIGHTING

(71) Applicant: ADOBE INC., SAN JOSE, CA (US)

(72) Inventors: Kevin Duarte, San Jose, CA (US); Wei-An Lin, San Jose, CA (US); Ratheesh Kalarot, San Jose, CA (US); Shabnam Ghadar, Menlo Park, CA (US); Jingwan Lu, Sunnyvale, CA (US); Elya Shechtman, Seattle, WA (US)

(21) Appl. No.: 18/452,827

(22) Filed: Aug. 21, 2023

(51) Int. Cl. G06T 11/60

(52) U.S. Cl. CPC G06T 11/60

(57) ABSTRACT

One or more aspects of a method, apparatus, and non-transitory computer readable medium include obtaining an input latent vector for an image generation network and a target lighting representation. A modified latent vector is generated based on the input latent vector and the target lighting representation, and an image generation network generates an image based on the modified latent vector using.

### BACKGROUND

The present disclosure relates to image lighting. Images can capture a scene in time and provide a depiction of the objects and background at that instant. Human eyes are trained to detect chroma (color) and luminance (light) in an image. Luminance is a measure of light given off or reflected from an object, where the eye can detect a difference in luminance as contrast. In some cases, image editing applications may be used to adjust the chroma or luminance of an image.

### SUMMARY

Embodiments of the present disclosure provide a machine learning model including a generative network to adjust the visual appearance of an input image based on a lighting representation, and provide an image having different lighting features in response to a user prompt. A lighting-conditional mapper can transform a latent representation of an input image to generate the same image with a new image latent representation having different lighting.

A method, apparatus, and non-transitory computer readable medium for relighting an image are described. One or more aspects of the method, apparatus, and non-transitory computer readable medium include obtaining an input latent vector for an image generation network and a target lighting representation, generating a modified latent vector based on the input latent vector and the target lighting representation, and generating an image based on the modified latent vector using an image generation network.

A method, apparatus, and non-transitory computer readable medium for training an image generation network are described. One or more aspects of the method, apparatus, and non-transitory computer readable medium include obtaining an input latent vector for the image generation network and a target lighting representation, and generating a training image based on the input latent vector and the target lighting representation using the image generation network. One or more aspects further include computing a lighting loss based on the training image, and training the image generation network to generate images with a target lighting based on the lighting loss.

A method, apparatus, and non-transitory computer readable medium for an image generation network are described. One or more aspects of the method, apparatus, and non-transitory computer readable medium include one or more processors, one or more memories including instructions executable by the one or more processors, and an image generation network comprising parameters stored in the one or more memories, wherein the image generation network takes a target lighting representation as input and is trained to generate images based on the target lighting representation using a lighting loss.

### BRIEF DESCRIPTION OF THE DRAWINGS

FIG. 1 is an illustrative depiction of a high-level diagram of users interacting with a relighting system, according to aspects of the present disclosure.

FIG. 2 a block diagram of an example of a method of generating a new image with different lighting from an original image, according to aspects of the present disclosure.

FIG. 3 shows a block diagram illustrating an example of relighting system, according to aspects of the present disclosure.

FIG. 4 shows a block diagram of a relighting model and workflow, according to aspects of the present disclosure.

FIG. 5 shows a block diagram illustrating an example of a latent mapper architecture, according to aspects of the present disclosure.

FIG. 6 shows a block diagram of an example of a method of training a relighting model, according to aspects of the present disclosure.

FIG. 7 shows a block/flow diagram of an example of a method of calculating reconstruction losses for training a relighting model, according to aspects of the present disclosure.

FIG. 8 shows a block/flow diagram of an example of a method of calculating consistency losses for training a relighting model, according to aspects of the present disclosure.

FIG. 9 shows a block diagram of an example of a method of calculating a lighting prediction loss for training a relighting model, according to aspects of the present disclosure.

FIG. 10 shows an example of a guided generative adversarial network (GAN), according to aspects of the present disclosure.

FIG. 11 shows a block diagram of an example of a method of generating a relighted image, according to aspects of the present disclosure.

FIG. 12 shows a block diagram of an example of a method of training a relighting model, according to aspects of the present disclosure.

FIG. 13 shows a block diagram of an example of a method of calculating a combination of losses for training, according to aspects of the present disclosure.

FIG. 14 shows an example of a computing device for a relighting model, according to aspects of the present disclosure.

### DETAILED DESCRIPTION

The present disclosure relates to image lighting. Some embodiments include relighting digital images (i.e., adjusting the apparent lighting of an image from a first state to a modified state) based on a user prompt. Image lighting or relighting can be utilized to provide visually pleasing photography, particularly for face portrait images.

In some cases, image relighting can be performed using an image editing application. However, the process can be difficult and time consuming when performed manually. Furthermore, machine learning models for performing image manipulation can depend on large amounts of labeled training data, which can be difficult and expensive to obtain.

Some machine learning models, such as generative adversarial networks (GANs), include the use of a mapping network to map points in an initial latent space to an intermediate latent space and the use of noise as a source of variation at each point in the generator model, where the intermediate latent space may be used to control style at each point in the generator model. Some GANs, such as a StyleGAN network, can disentangle the latent factors of variation. In generative modeling, one aim is to solve the general problem of learning a joint distribution over all the variables. In contrast, a discriminative model takes pixel values directly as input and maps them to the labels as output.

A variational auto-encoder (VAE) is another machine learning model that can be used for image generation. A VAE can be viewed as two coupled, but independently parameterized models: the encoder or recognition model, and the decoder or generative model. These two models support each other. The recognition model delivers to the generative model an approximation to its posterior over latent random variables. A convolutional neural network takes as input the raw pixels of an image and encodes high-level features that lie in a latent space in the final layer.

In various embodiments, a method to automatically relight images is provided. The image relighting method can involve a lighting-conditional mapper, that transforms the latent representation of a machine learning model such as a StyleGAN. Given a lighting representation and an input image latent representation, the mapper can output a new image latent representation that can generate the same image with different lighting. The lighting of the image can be represented by one or more latent variables, where different latent variables can encode different latent features of the image. The different latent variables and associated latent features can be uncorrelated.

In various embodiments, the network architecture can be trained and used to generate an image with a new lighting scheme. A machine learning model can be utilized to learn to map the latent representation and lighting representation to a new latent representation. In some examples, the image encoder and the generator can be pre-trained networks, which are fixed. The latent mapper can take the form of a multi-layer neural network, where the latent mapper can learn to map the latent representation and lighting representation to a new latent representation. The latent mapper can be a latent-to-latent mapper that produces changes in illumination/lighting.

In various embodiments, a re-lighting network that works on the latent space can be trained to output a new latent vector from an input latent vector and a lighting representation. The new latent vector can be used to generate an image with the new lighting scheme. In some embodiments, a GAN takes as input a random input vector z from some prior distribution and outputs and image G(z). The goal of the model is to learn to generate the underlying distribution of the real dataset. The input of a GAN acts as a latent vector because it encodes the output image G(z) in a low-dimensional vector z. A random input vector may be generated, and the input latent vector can be generated based on the generated random input vector.

To successfully edit a real image, one may first convert the input image into latent variables. However, it is still challenging to find latent variables, which have the capacity for preserving the appearance of the input subject. It is difficult to find a latent representation that provides the capacity for accurate reconstruction of an input image, as well as realistic editing of the input image. The latent space of a machine learning model such as StyleGAN has disentangled properties; however, that provide an opportunity to control different factors of variations in the image with each of the latent variables.

Accordingly, embodiments of the disclosure improve on changing the illumination of a digital image based on a user's preference. The re-lighting process can be performed in the latent representation of a StyleGAN, which allows for high-resolution outputs produced at a high frame rate. The described approach can perform more subtle changes in lighting, thereby providing more realistic lighting. Shadows generated by the described method are also more realistic and better models of the geometry of the face, for example, of shadows generated by the nose and face contours. Furthermore, the approach successfully transfers extremely small details like the motion of the light in the eyes.

### Network Architecture

One or more aspects of the apparatus and method include one or more processors; a memory coupled to and in communication with the one or more processors, wherein the memory includes instructions executable by the one or more processors to perform operations including:

In various embodiments, a Generative Adversarial Networks (GAN) architecture can be used to generate a new image having different lighting features from an original image. A latent mapper can learn to map the initial latent representation and lighting representation to a new latent representation. The image encoder and StyleGAN can be pre-trained networks which are fixed.

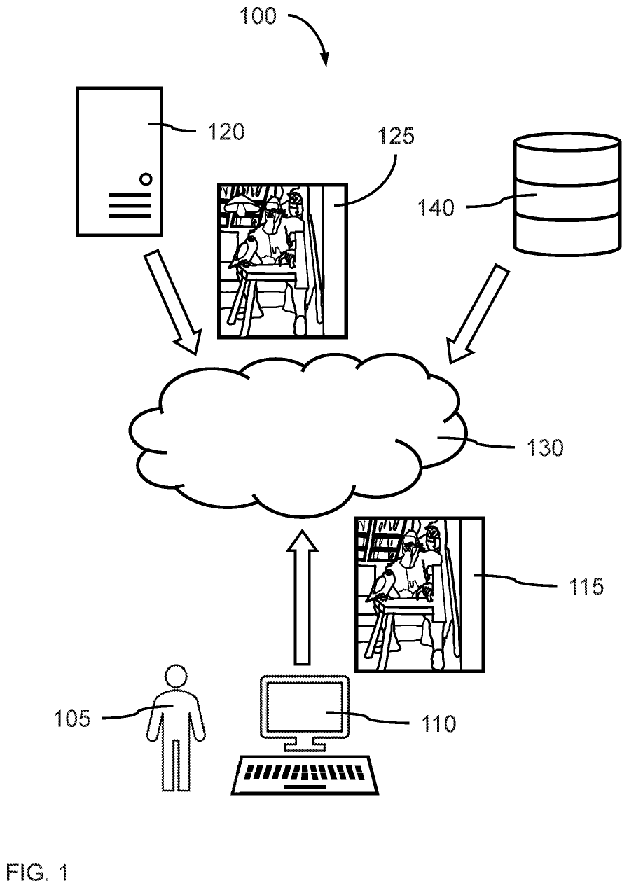

FIG. 1 is an illustrative depiction of a high-level diagram of users interacting with a relighting system, including a neural network for generating relighted images, according to aspects of the present disclosure.

In various embodiments, a relighting system 120 can involve a user 105 who can interact with relighting system software on a user device 110. A user 105 may interact with the relighting system 120 using, for example, a desktop computer, a laptop computer, a handheld mobile device, for example, a smart phone, a tablet, a smart tv, or other suitably configured user device. The user device 110 can communicate with the relighting system 120, which can be a server located on the cloud 130. The relighting system 120 can generate a new image 125 in response to a user prompt, where the user indicates a new lighting scheme to be applied to an original image 115.

Embodiments of the disclosure can be implemented in a server operating from the cloud 130, where the cloud 130 is a computer network configured to provide on-demand availability of computer system resources, such as data storage and computing power. In some examples, the cloud 130 provides resources without active management by the user 105. The term cloud is sometimes used to describe data centers available to many users over the Internet. Some large cloud networks have functions distributed over multiple locations from central servers. A server is designated an edge server if the server has a direct or close connection to a user. In some cases, a cloud 130 is limited to a single organization. In other examples, the cloud 130 is available to many organizations. In an example, a cloud 130 includes a multi-layer communications network comprising multiple edge routers and core routers. In another example, a cloud 130 is based on a local collection of switches in a single physical location.

In various embodiments, the functions of the relighting system 120 can be located on or performed by the user device 110. Images and other resources for relighting can be stored on a database 140. User device 110 may be a personal computer, laptop computer, mainframe computer, palmtop computer, personal assistant, tablet, smart phone, mobile device, or any other suitable processing apparatus. In various embodiments, a user device 110 includes software that incorporates a relighting system application and relighting model. In some examples, the relighting system application on the user device may include functions of relighting system 120.

In various embodiments, a user interface may enable user 105 to interact with the user device 110. In some embodiments, the user interface may include an audio device, such as an external speaker system, an external display device such as a display screen, and/or an input device (e.g., remote control device interfaced with the user interface directly or through an I/O controller module). In various embodiments, a user interface may be a graphical user interface (GUI). In various embodiments, a user interface may be represented in code which is sent to the user device and rendered locally by a browser.

In various embodiments, a relighting system 120 can include a computer implemented network comprising a user interface, a machine learning model, which can include a natural language processing (NLP) model and a relighting model. The relighting system 120 can also include a processor unit, a memory unit, a relighting model, a training component, a noise component, and an image generation network (e.g., GAN, StyleGAN, etc.). The training component can be used to train one or more machine learning models. Additionally, relighting system 120 can communicate with a database 140 via cloud 130. In some cases, the architecture of the neural network is also referred to as a network or a network model. The neural network model can be trained to generate a relighted image based on user input using a neural network training technique.

In various embodiments, relighting system 120 can generate a vector representing the relighting scheme converted from the user's natural language text input. The description can include text indicating features to be lightened or darkened, which may be interpreted using a natural language processing (NLP) model (e.g., BERT, GPT, etc.).

In various embodiments, relighting system 120 is implemented on a server. A server provides one or more functions to users linked by way of one or more networks. In some cases, the server can include a single microprocessor board, which includes a microprocessor responsible for controlling aspects of the server. In some cases, a server uses on or more microprocessors and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

A database 140 is an organized collection of data, where for example, database 140 can store data in a specified format known as a schema. Database 140 may be structured as a single database, a distributed database, multiple distributed databases, or an emergency backup database. In some cases, a database controller may manage data storage and processing in database 140. In some cases, a user 105 interacts with the database controller. In other cases, a database controller may operate automatically without user interaction. The database may store a plurality of images.

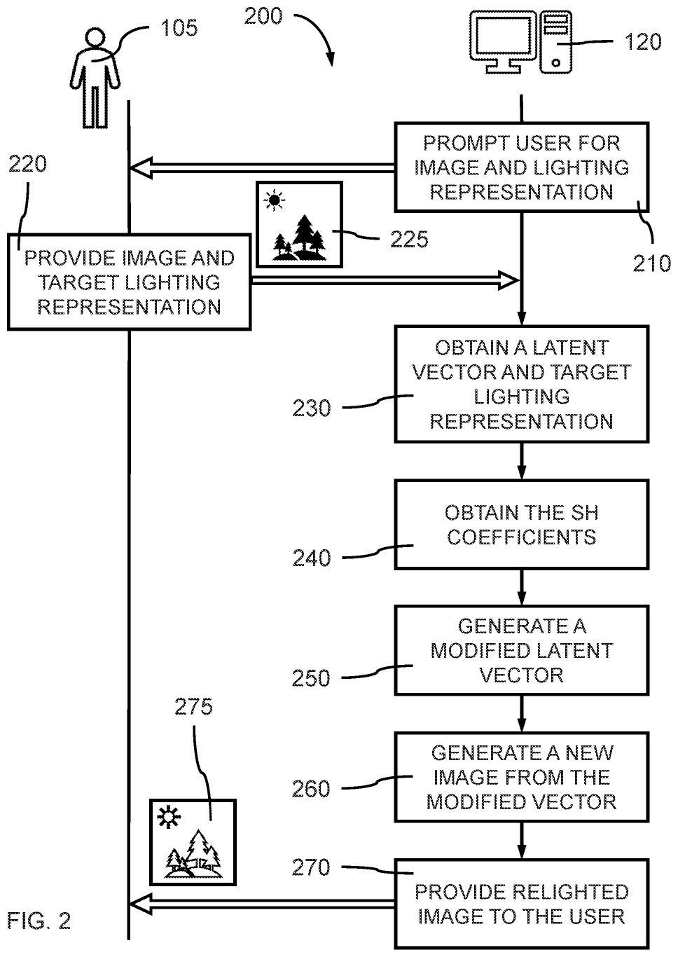

FIG. 2 a block diagram of an example of a method of generating a new image with different lighting from an original image, according to aspects of the present disclosure.

In various embodiments, a user 105 can obtain a new image 275 with different lighting from an original image 225 by providing the original image 225 to a relighting system 120.

At operation 210, the relighting system 120 can prompt the user 105 to identify an image and provide a lighting representation, where the lighting representation can indicate changes to the original image 225 relating to the brightness and darkness of features in the image. The lighting representation can be a vector including Spherical Harmonic (SH) coefficients.

At operation 220, the user 105 can provide an image and the target lighting representation to the relighting system 120, where the user may send the original image 225 to the relighting system, or identify an image to be relighted on a database 140 or the server of the relighting system 120. The target lighting representation can be a vector in a lighting representation space.

In various embodiments, the target lighting representation can be obtained by having the user provide the spherical harmonic coefficients directly, where the user can input each coefficient value separately.

In various embodiments, the target lighting representation can be obtained by having the user provide offset values to the initial spherical harmonic coefficients obtained from the original image, where the initial spherical harmonic coefficients can be predicted from the original image. The initial spherical harmonic coefficients may be predicted from the original image using a trained network model. The offset values can be added to the initial spherical harmonic coefficients to obtain the new lighting representation.

In various embodiments, the target lighting representation can be obtained by having the user provide a reference image from which the spherical harmonic coefficients can be estimated, and the estimated SH coefficients obtained from the reference image can be used to generate the new lighting representation and relight the original image.

At operation 230, the relighting system can obtain an initial latent vector from the original image and the target lighting representation. The initial latent vector can be generated by a pre-trained image encoder of a relighting model, where the pre-trained image encoder can be a pre-trained GAN inversion model. The target lighting representation can be a vector in a lighting representation space.

At operation 240, the spherical harmonic (SH) coefficients for the lighting features of the original image 225 can be obtained. A pretrained image encoder from a 3d-Morphable-Model (3DMM DECA) can be used to estimate the spherical harmonic coefficients from the original image 225, where the pretrained image encoder can be a component of the relighting system 120.

At operation 250, the relighting system can generate a modified latent vector for the image from the initial latent vector and the vector for the target lighting representation using a latent mapper. The initial latent vector can be from a StyleGAN latent space. The modified latent vector can be used to generate a new image with the new lighting, where the subject of the original image 225 remains identifiable, while the illumination/lighting features of the subject are changed. The new image depicts an object (e.g., a face) that is lit according to the target lighting representation.

At operation 260, a new image 275 can be generated by an image generation network (e.g., GAN, StyleGAN, Diffusion Model, etc.) from the modified latent vector generated by a latent mapper. The new image 275 can be based on the original image 225 and the modified latent vector.

In various embodiments, an additional image can be generated based on an additional latent vector, where the additional image shares an attribute with the original image 225 but has different lighting from the original image 225 and new image 275 according to the additional lighting representation.

In various embodiments, an additional lighting representation may be obtained, and an additional modified latent vector may be generated based on the input latent vector and the additional lighting representation. An additional image may be generated based on the additional latent vector, wherein the additional image shares an attribute with the initial generated image, but has different lighting from the initial generated image according to the additional lighting representation.

At operation 270, the new image 275 having relighted features can be provided to the user 105. The new image 275 can be communicated from the relighting system 120 to the user device 110.

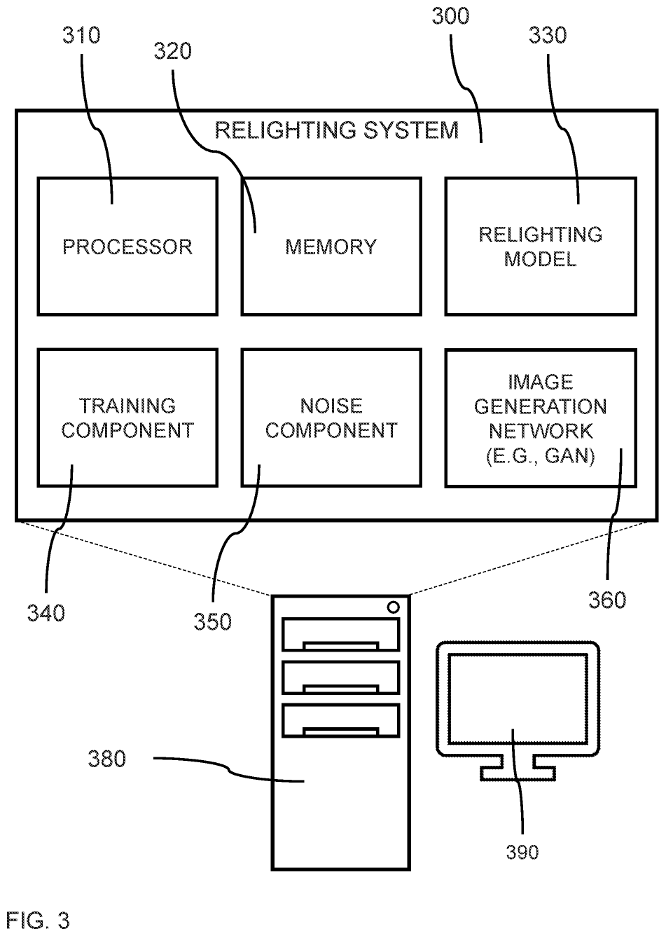

FIG. 3 shows a block diagram illustrating an example of relighting system, according to aspects of the present disclosure.

In one or more embodiments, a relighting system 300 can obtain an original image 225 including original content and receive a text description or lighting representation indicating lighting/illumination changes to be made to the original image 225.

In various embodiments, the relighting system 300 can include a computer system 380 including one or more processors 310, computer memory 320, a relighting model 330, a training component 340, a noise component 350, and an image generation network 360. The computer system 380 of the relighting system 300 can be operatively coupled to a display device 390 (e.g., computer screen) for presenting prompts and images to a user 105, and operatively coupled to input devices to receive description input from the user.

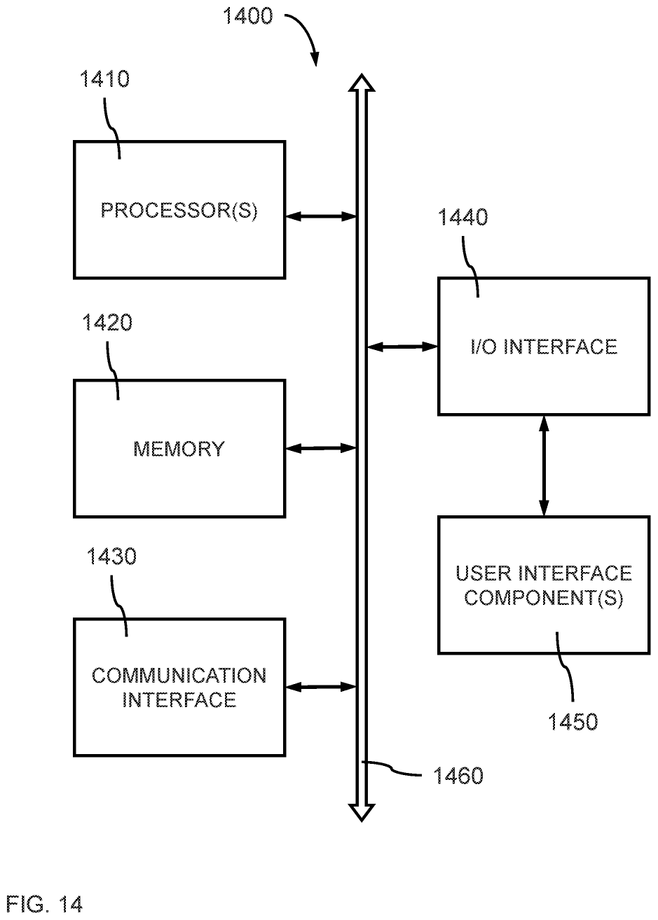

According to some aspects, processor unit 310 includes one or more processors. Processor unit 310 can be an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 310 is configured to operate a memory array using a memory controller. In other cases, a memory controller is integrated into the processor. In some cases, processor unit 310 is configured to execute computer-readable instructions stored in a memory to perform various functions. In some embodiments, processor unit 310 includes special-purpose components for modem processing, baseband processing, digital signal processing, or transmission processing. Processor unit 310 is an example of, or includes aspects of, the processor described with reference to FIG. 14.

According to some aspects, memory unit 320 comprise a memory coupled to and in communication with the one or more processors 310, where the memory 320 includes instructions executable by the one or more processors 310 to perform operations. Examples of memory unit 320 include random access memory (RAM), read-only memory (ROM), or a hard disk. Examples of memory unit 320 include solid-state memory and a hard disk drive. In some examples, memory unit 320 is used to store computer-readable, computer-executable software including instructions that, when executed, cause a processor 310 to perform various functions described herein. In some cases, memory unit 320 contains, among other things, a basic input/output system (BIOS), which controls basic hardware or software operation, such as the interaction with peripheral components or devices. In some cases, a memory controller operates memory cells. For example, the memory controller can include a row decoder, column decoder, or both. In some cases, memory cells within memory unit 320 store information in the form of a logical state. Memory unit 320 is an example of, or includes aspects of, the memory subsystem described with reference to FIG. 14.

In various embodiments, relighting model 330 can generate a vector representing the original image 225 and a lighting description, that may be a lighting representation (e.g., Spherical Harmonic (SH) coefficients) or generated from a reference image or the user's natural language text input. The lighting description can include text indicating a change in illumination to be applied to the original image 225, where the relighted new image 275 is generated based on the subject and features of the original image 225 and the lighting description. In some aspects, a prompt from the relighting system 300 includes an original image 225 presented to the user 105 on the display device 390 or communicated to the user's device 110. The relighting model 330 can include an encoder/decoder model, where the image encoder can generate a latent vector from the original image 225, where image features can be represented as the latent vector.

The Spherical Harmonic (SH) coefficients are based on basis functions, which can be scaled and combined to produce an approximation to an original function. Using a projection process over all the basis functions returns a vector of approximation coefficients. The associated Legendre polynomials are utilized for the Spherical Harmonics defined across the surface of a sphere, where the Spherical Harmonics can be used for a computer lighting model.

In various embodiments, training component 340 can receive a training data set for the relighting system 300, relighting model 330, and image generation network 360, and apply one or more loss function(s) to results obtained from the model(s) being trained using the training data set. The training component 340 can update the model weights of the relighting model 330, and/or image generation network 360 based on the results of the applied loss function. A single-stage training algorithm, that learns to generate a lighting representation and/or generate an image, can be used.

In various embodiments, noise component 350 generates a noise map based on the original image 225, where the new image 275 can be generated based on the noise map.

According to some aspects, image generation model 360 generates a new image 275 having relighted features, including the original content from the original image 225 and the modified illumination/lighting using an image generation model 360, that can take the latent vector generated from the description by the transformer/encoder of the relighting model 330 as input. In some aspects, the outputted new image 275 combines additional content in a manner consistent with the original content. In various embodiments, image generation model 360 produces a set of new images 275, as output.

In various embodiments, a diffusion model (DF) can be used as the image generation model 360 to generate the relighted new image 275, where an image encoder can invert the image into the diffusion models' latent space. The new image 275 can be the relighted version of the original image 225 output by the image generation model 360 and provided to the user 105.

Diffusion models are a class of generative models that convert Gaussian noise into images from a learned data distribution using an iterative denoising process. Diffusion models are also latent variable models with latents, z={zₜ|t∈[0, 1]}, that obey a forward process q(z|x) starting at data x˜p(x). This forward process is a Gaussian process that satisfies the Markovian structure. For image generation, the diffusion model is trained to reverse the forward noising process (i.e., denoising, zₜ˜q(z|x)). In addition, a text embedding from the natural language processor (NLP) can be used as a conditioning signal that guides the denoising process. A text encoder can encode the input text of the description into text embeddings, where the diffusion model maps the text embedding into an image.

In various embodiments, the computation and parameters in a diffusion model take part in the learned mapping function which reduces noise at each timestep (denoted as F). The model takes as input x (i.e., noisy or partially denoised image depending on the timestep), the timestep t, and conditioning information the model was trained to use. In some cases, the conditioning information can be a text prompt (e.g., TP, “ ”, and AP are text prompts). Classifier-free guidance is a mechanism to vary and control the influence of the conditioning on the sampled distribution at inference. In some cases, the conditioning can be replaced by the null token (i.e., the empty string, “ ”, in case of text conditioning) during training. A single scalar can control effect of the conditioning during inference.

Some examples of the method, apparatus, non-transitory computer readable medium, and system further include iteratively producing a plurality of output images. Some examples further include generating an iterative noise map for each of the plurality of output images with successively reduced noise to produce the output image.

In various embodiments, a stable diffusion model can be used as the base generative model, and masked image synthesis method with stochastic differential equations may be used as a baseline. Note that the same hyperparameters (i.e., noise strength, total diffusion steps, sampling schedule, classifier free guidance strength C) can be used.

In various embodiments, the text encoder can be a generic large language model pre-trained on text-only corpora, or a custom-trained text encoder.

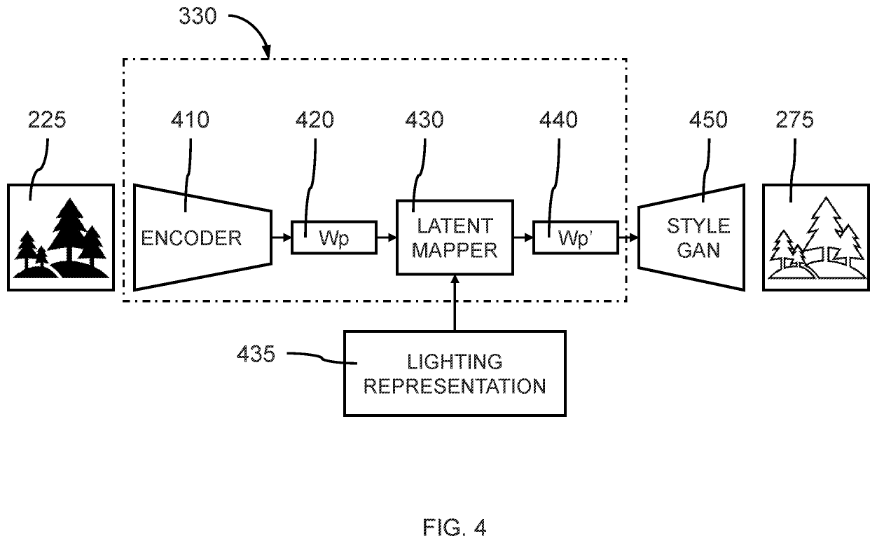

FIG. 4 shows a flow diagram of a relighting model and workflow, according to aspects of the present disclosure.

In various embodiments, a relighting model 330 can be based on the StyleGAN latent space, where an input latent vector, Wₚ, 420 and a lighting representation, Lᵣ, 435 can be a target lighting representation used to generate a new latent vector, Wₚ′, 440, where the new latent vector, Wₚ′, 440 can be a modified latent vector. The new latent vector, Wₚ′, 440 (modified latent vector) can be used to generate a new image 275 with the new lighting using, for example, a StyleGAN 450 image generation network 360. Other GAN models may also be used to generate the relighted image, where the GAN has a latent representation used to generate the image, and the GAN has a pre-trained GAN inversion model that obtains a latent representation from the input image 225.

In various embodiments, the relighting model 330 can include an image encoder 410, and a latent mapper 430, where the image encoder 410 can be pre-trained to generate the input latent vector, Wₚ, 420, and the latent mapper 430 can be pre-trained to map the input latent vector, Wₚ, 420 and target lighting representation, Lᵣ, 435 to the new latent vector, Wₚ′, 440 (modified latent vector).

In various embodiments, the image encoder 410 can receive the original image 225 and output the input latent vector, Wₚ, 420, which can be fed to the latent mapper 430. The latent mapper 430 can receive the input latent vector, Wₚ, 420, and the target lighting representation, Lᵣ, 435, and generate the new latent vector, Wₚ′, 440. The new latent vector, Wₚ′, 440 can be fed to the StyleGAN to generate the new relit image 275.

In various embodiments, a scene includes objects, light sources, and a camera or viewpoint, that can be converted into a two-dimensional image 225, 275 made up of pixels. A shading model can describe how an object's color and appearance should vary based on factors, including surface orientation, viewpoint/direction, and lighting, including the direction and intensity of light sources.

A transformer or transformer network is a type of neural network model used for processing tasks. A transformer network transforms one sequence into another sequence (e.g., words, pixels) using an encoder and a decoder. The encoder and decoder include modules that can be stacked on top of each other multiple times. The modules comprise multi-head attention and feed forward layers. The inputs and outputs are first embedded into an n-dimensional space. Positional encoding of different words (i.e., give every word/part in a sequence a relative position since the sequence depends on the order of its elements) are added to the embedded representation (n-dimensional vector) of each word. In some examples, a transformer network includes an attention mechanism, where the attention looks at an input sequence and decides at each step which other parts of the sequence are important.

The attention mechanism involves query, keys, and values denoted by Q, K, and V, respectively. Q is a matrix that contains the query (vector representation of one word in the sequence), K represents all the keys (vector representations of all the words in the sequence), and V is the values, which is the vector representations of all the words in the sequence. For the encoder and decoder, multi-head attention modules, V consists of the same word sequence as Q. However, for the attention module that is taking into account the encoder and the decoder sequences, V is different from the sequence represented by Q. In some cases, values in V are multiplied and summed with some attention-weights, a.

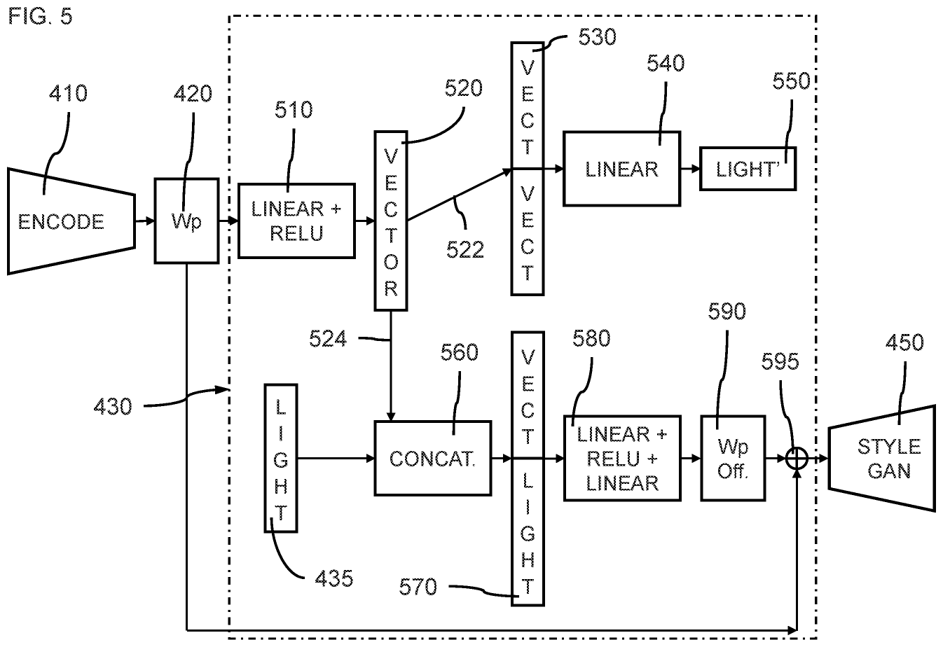

FIG. 5 shows a block diagram illustrating an example of a latent mapper architecture, according to aspects of the present disclosure.

In various embodiments, an image encoder 410 can generate the input latent vector, Wₚ, 420, which can take the form of 18 512-dimensional vectors, that can be used as input to the latent mapper 430.

In various embodiments, the latent mapper 430 can be a multi-layer neural network, where the multi-layer neural network of the latent mapper 430 can include a fully connected layer 510, a linear activation layer 540, and two fully connected layers 580. The latent mapper 430 can be trained to produce a new latent vector, Wₚ′, 440, which can generate images with the correct lighting.

In various embodiments, the 18 latent vectors of the input latent vector, Wₚ, 420 can be passed through a fully connected layer 510 with ReLU activation. In various embodiments, fully connected layer 510 has one layer. In various embodiments, fully connected layer 510 can generate 18 512-dimensional intermediate vectors 520. The fully connected layer 510 with ReLU activation can feed the 18 512-dimensional intermediate vectors 520 into two branches.

In various embodiments, the first branch 522 can combine all 18 512-dimensional vectors, that can be a flattened vector, by concatenation to produce a 9,216 dimensional latent lighting vector 530. The latent lighting vector 530 can be fed to a linear activation layer 540 to predict the original lighting representation 550 (Light′) for the inputted original image 225. The original lighting features can be embedded in the latent lighting vector 530, and the original lighting representation 550 can be predicted/estimated.

In various embodiments, the second branch 524 can combine each of the 18 vectors 520 from the fully connected layer 510 with the target lighting representation, Lᵣ, 435, through concatenation 560 to produce a concatenated vector 570, and passes the concatenated vector 570 through two fully connected layers 580 to obtain the output latent vector offsets 590. The output latent vector offsets 590 are added 595 to the original input latent vector, Wₚ, 420, to produce the new latent vector, Wₚ′, 440, which can be fed to the StyleGAN 450 image generator to obtain the new, re-lit image 275. The latent vector offsets 590 can be considered the direction in latent space involved in changing the lighting, while keeping the rest of the scene the same.

### Training:

Embodiments of the disclosure can utilize an artificial neural network (ANN), which is a hardware and/or a software component that includes a number of connected nodes (i.e., artificial neurons), which loosely correspond to the neurons in a human brain. Each connection, or edge, transmits a signal from one node to another (like the physical synapses in a brain). When a node receives a signal, the nodes processes the signal and then transmits the processed signal to other connected nodes. In some cases, the signals between nodes comprise real numbers, and the output of each node is computed by a function of the sum of the node's inputs. In some examples, nodes may determine their output using other mathematical algorithms (e.g., selecting the max from the inputs as the output) or other suitable algorithms for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the layer's inputs. The initial layer is known as the input layer and the last layer is known as the output layer. In some cases, signals traverse certain layers multiple times.

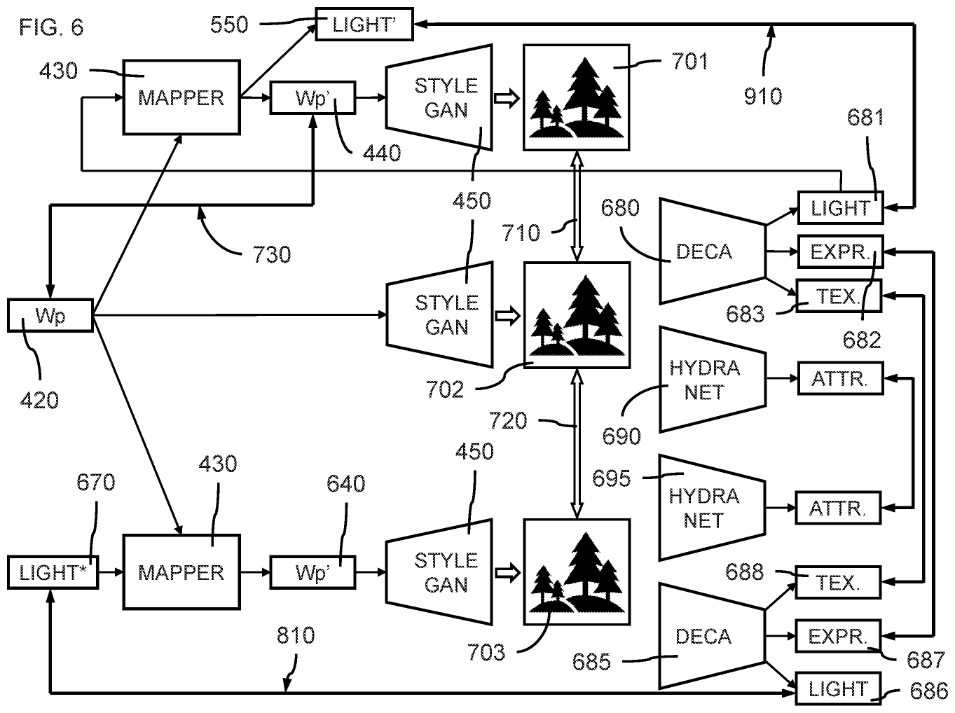

FIG. 6 shows a block diagram of an example of a method of training a relighting model, according to aspects of the present disclosure.

In various embodiments, the StyleGAN 450 can be the pre-trained image generation network 360. Each of the three illustrated StyleGANs in FIG. 6 represent a separate forward pass through the same pre-trained StyleGAN. Spherical Harmonic (SH) coefficients 681, 686 (i.e., the lighting representation) are different values obtained from different images, and an expression vector 682, 687 are different values that can be obtained from a pre-trained 3d-Morphable-Model (3DMM) Detailed Expression Capture and Animation (DECA) model 680, 685 (hereafter referred to as DECA).

The DECA is a pre-trained image encoder, that is differentiable to allow for back-propagation for training. The DECA pre-trained image encoder can predict lighting/expression/texture vectors. Detailed Expression Capture and Animation (DECA) is trained to robustly produce a UV displacement map for training from a low-dimensional latent representation that consists of person-specific detail parameters and generic expression parameters, while a regressor is trained to predict detail, shape, albedo, expression, pose and illumination parameters from a single image. An individual's face shows different details (e.g., wrinkles), depending on the facial expressions, but other properties of their shape remain unchanged. A detail-consistency loss can disentangle person-specific details from expression-dependent wrinkles.

In various embodiments, Shape is a 100 dimension vector representing the shape of the person's face, Albedo is a 50 dimension vector representing the “color” of the objects (person) in the scene (this color is supposed to be independent of lighting conditions). Expression is a 50 dimension vector representing the persons' facial expression. Pose is a 6 dimension vector representing the head and jaw pose (e.g., yaw, pitch, roll). Illumination is the 27 dimension SH coefficient parameters.

In various embodiments, an L2 Reconstruction Loss and LPIPS Loss 710 can be applied to the comparison of image 701 generated using the new latent vector, Wₚ′, 440 produced by the latent mapper 430, and the image 702 generated directly using the original input latent vector, Wₚ, 420.

In various embodiments, a LPIPS Loss 720 can be applied to the comparison of image 702 generated using the original input latent vector, Wₚ, 420, and image 703 generated using the alternate latent vector, Wₚ*, 640 produced by the latent mapper 430, whose input is the original input latent vector, Wₚ, 420 and some new lighting parameters 670 (LIGHT*).

In various embodiments, a latent L1 regularization term 730 and a SH consistency loss 810 may be applied.

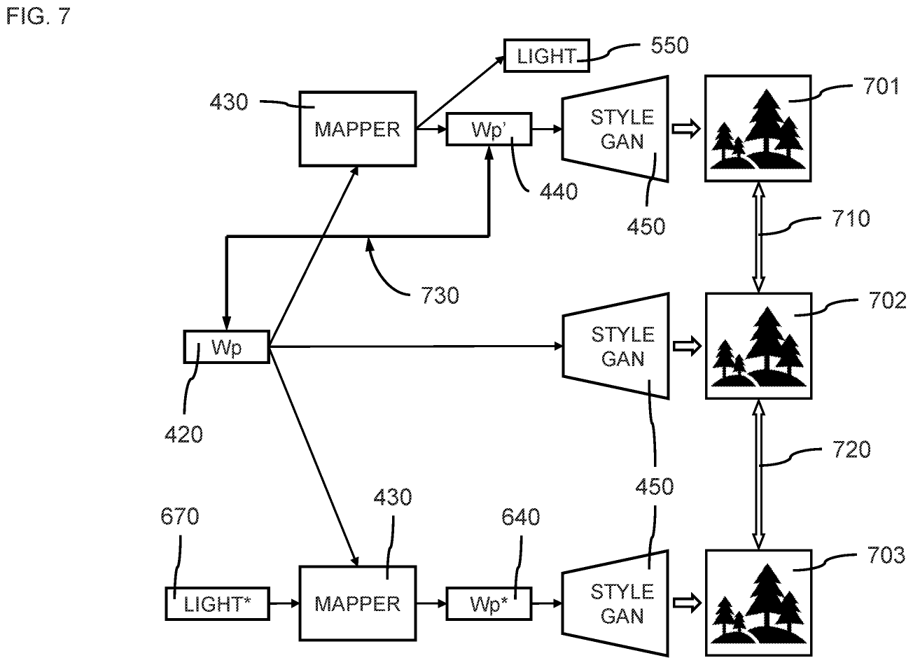

FIG. 7 shows a block/flow diagram of an example of a method of calculating reconstruction losses for training a relighting model, according to aspects of the present disclosure.

In various embodiments, three images 701, 702, 703 are generated by the same StyleGAN network 450 utilizing three separate passes. The first image 701 is the image generated when using the new latent vector, Wₚ′, 440 produced by the latent mapper 430, whose input is the original input latent vector, Wₚ, 420 and the original target lighting representation, Lᵣ, 435. The second image 702 is generated directly using the original input latent vector, Wₚ, 420. The third image 703 is the image generated using the alternate latent vector, Wₚ*, 640 produced by the latent mapper 430, whose input is the original input latent vector, Wₚ, 420 and some new lighting parameters 670 (LIGHT*).

In various embodiments, to ensure that the network produces latent vectors within the correct latent vector, Wₚ, distribution, an L2 reconstruction loss can be used. For a given Wₚ vector, the SH coefficients 550 can be extracted (i.e., generate the face image and pass it through DECA), and pass the Wₚ and SH coefficients through the latent mapper 430. The resulting Wₚ′ vector 440 should generate a reconstruction of the original image. The latent vector, Wₚ, distribution is the vector which is input to the StyleGAN 450 to generate images 701, 702, 703. The “correct” Wₚ distribution is the set/distribution of vectors, such that the StyleGAN 450 would generate a realistic image. For example, if a Wₚ vector is of completely random values inputted to the StyleGAN 450, a realistic image would not be generated. In contrast, the latent mapper 430 can produce latent Wₚ′ vectors 440, such that the StyleGAN 450 network generates realistic images.

In various embodiments, for calculating the L2 Reconstruction loss, the calculation is minimizing the following:

(G(WP_{ORIG})−G(WP′))²;
where WP_{ORIG} is the original input Wₚ vector, and Wₚ′ is the Wₚ vector 440 output by the latent mapper 430. Here, G(·) is the GAN network, which generates an image when given a Wₚ vector.

Perturbations in some dimensions of the WP space can lead to noticeable changes in face pose, expression, or identity. A perceptual loss (LPIPS) can be applied to both the latent reconstruction (same WP and SH) and other latent mapper 430 outputs with varied lighting (same WP but different SH) to reduce changes in the face.

The LPIPS loss 720 is similar to the above L2 loss:

(F(G(WP_{ORIG}))−F(G(WP′)))²;
but it compares the deep features of two generated images. Here, F is a pretrained deep network (e.g., VGG-16), which outputs a feature vector representing the input image.

The L2 Reconstruction Loss and LPIPS Loss 710 can be combined to reduce changes in the face.

A latent L1 regularization term 730 can be used to ensure the input and output Wₚ of the latent mapper 430 are similar. The latent L1 regularization loss term 730 minimizes the absolute difference of the input and output latent vectors:

[WP_{ORIG}−WP′].

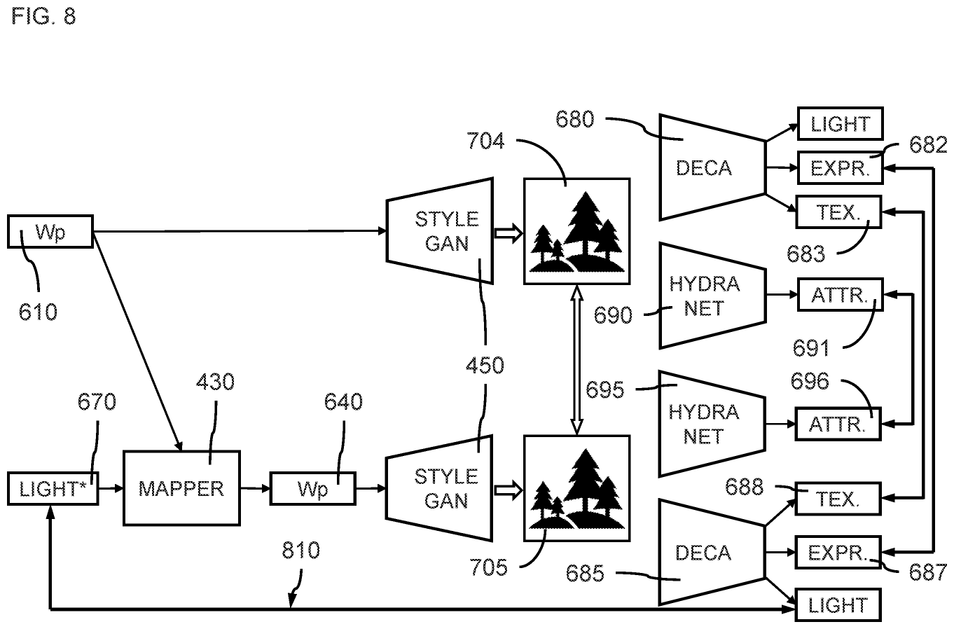

FIG. 8 shows a block/flow diagram of an example of a method of calculating consistency losses for training a relighting model, according to aspects of the present disclosure.

In various embodiments, the latent mapper 430 can learn to produce W_{P}′ latent vectors 440, which generate images with the correct lighting corresponding to the input lighting representation (e.g., SH coefficients). For a batch of latent vectors 420, the SH coefficients can be obtained for each image, then the latent mapper 430 can be used to generate the new latent vector, Wₚ′, 440, with different lighting from original target lighting representation, Lᵣ, 435. The difference between the input SH coefficients can be minimized and output by the DECA model 680, 685. The SH consistency loss 810 can be back-propagate through the relighting model to adjust new lighting parameters 670 (LIGHT*) to generate alternate latent vector, Wₚ*, 640. The SH consistency loss 810 allows images to be relit without having any paired or “ground-truth” images to train with. Using the SH consistency loss 810, the latent mapper 430 can be trained for various conditions, where the condition discussed herein is lighting, when a differentiable feature estimator is available for the given condition.

With the previous losses, there can still be a large amount of entanglement between facial expression (eye openness, eyebrow raising, and mouth smiling) and the illumination/lighting. To reduce this entanglement, the expression vector(s) 682, 687, as well as the texture/albedo vector(s) 683, 688, produced by the 3DMM DECA model 680, 685 during training, can be used. By minimizing the difference between an expression vector of inputs and the outputs of the latent mapper 430, the change in expression can be reduced when the lighting changes. The same process can be performed for the texture/albedo vector 683, 688 produced by the DECA model 680, 685. A pre-trained face attribute predictor 690, 695 (e.g., HydraNet) can be used to further maintain the aspects of the original face's identity. A face attribute predictor 690, 695 is a learned neural network, which takes a face image and outputs some feature description 691, 696 of the face. Some example output attributes are: age, gender, expression (smile, happiness, fear), hair color, head-pose, presence of headwear, facial hair, glasses, etc. This is the Attribute, Expression and Texture consistency loss. HydraNet is a learned neural network, which can predict the various attributes of a person's face. When given an image, HydraNet outputs a vector of attributes, where for different images of the same person, HydraNet should predict the same attributes. This is the Attribute, Expression and Texture consistency loss.

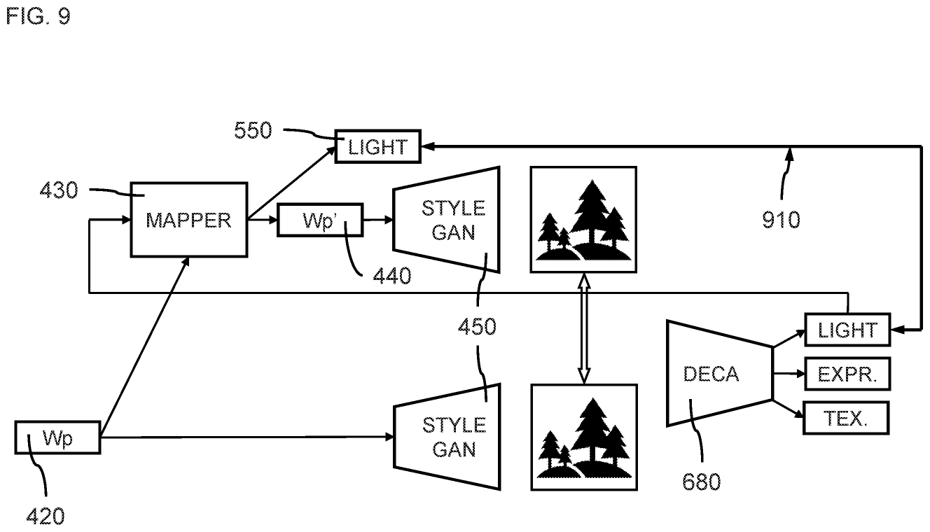

FIG. 9 shows a block/flow diagram of an example of a method of calculating a lighting prediction loss for training a relighting model, according to aspects of the present disclosure.

In various embodiments, to ensure that the relighting model 330 can predict the lighting for a given image, an SH Prediction Loss 910 can be calculated, which regresses the ground-truth lighting representation. The SH Prediction Loss 910 also allows for more stable training. It can predict the lighting ground-truth lighting representation. For a given image latent representation 610, the latent mapper 430 can predict/regress a lighting representation. This predicted lighting representation 660, can be similar to the ground-truth lighting representation (output of DECA 680).

In various embodiments, the latent mapper 430 can perform computations only on the latent vector, which allows for fast inference, as this light-weight network does not require image-level operations for each lighting condition. The consistency losses allow this method to be applicable to image domains other than faces, where a pre-trained lighting estimator exists. The pretrained lighting estimator can be the DECA model, 680, or may be a network that can take an image, as input, and output a lighting representation for that image (e.g., SH Coefficients). Other network models have been proposed to estimate lighting in image.

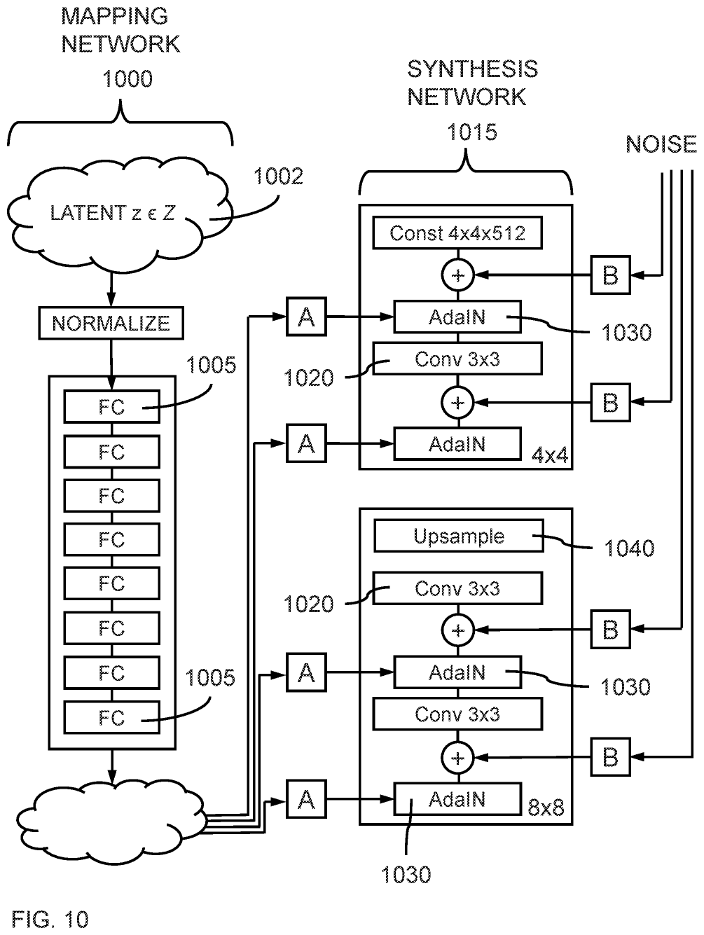

FIG. 10 shows an example of a guided generative adversarial network (GAN), according to aspects of the present disclosure.

The GAN includes a mapping network 1000 and a synthesis network 1015. The mapping network 1000 maps a random noise vector to the WP vector, referred to as reduced encoding, but is technically of higher dimensionality than the z vector. The synthesis network 1015 generates image output from the WP vector.

GANs are a group of artificial neural networks where two neural networks are trained based on a contest with each other. Given a training set, the network learns to generate new data with similar properties as the training set. For example, a GAN trained on photographs can generate new images that look authentic to a human observer.

GANs may be used in conjunction with supervised learning, semi-supervised learning, unsupervised learning, and reinforcement learning. In some examples, a GAN includes a generator network and a discriminator network. The generator network generates candidates, while the discriminator network evaluates them. The generator network learns to map from a latent space to a data distribution of interest, while the discriminator network distinguishes candidates produced by the generator from the true data distribution. The generator network's training objective is to increase the error rate of the discriminator network (i.e., to produce novel candidates that the discriminator network classifies as real).

The style generative adversarial networks (StyleGAN) is an extension to the GAN architecture that uses an alternative generator network including using a mapping network to map points in latent space to an intermediate latent space, using an intermediate latent space to control style at each point, and introducing noise as a source of variation at each point in the generator network.

In various embodiments, a mapping network 1000 includes a deep learning neural network comprised of fully connected (FC) layers 1005. In some cases, the mapping network 1000 takes a randomly sampled point from the latent space 1002 as input and generates a style vector as output.

In various embodiments, the synthesis network 1015 includes convolutional layers 1020, adaptive instance normalization (AdaIN) layers 1030, and an upsampling layer 1040. The synthesis network 1015 takes a constant value, for example, a constant 4×4×512 constant value as input in order to start the image synthesis process. The style vector generated from the mapping network 1000 is transformed and incorporated into each block of the synthesis network after the convolutional layers 1020 via the AdaIN operation. The AdaIN layers 1030 first standardize the output of a feature map to a standard Gaussian, then add the style vector as a bias term. In some cases, the output of each convolutional layer in the synthesis network is a block of activation maps. In some cases, the upsampling layer 1040 doubles the dimensions of input (e.g., from 4×4 to 8×8) and is followed by a convolutional layer 1020.

In various embodiments, Gaussian noise is added to each of these activation maps prior to the AdaIN operations. A different sample of noise is generated for each block and is interpreted using per-layer scaling factors. In some examples, the noise Gaussian introduces style-level variation at a given level of detail.

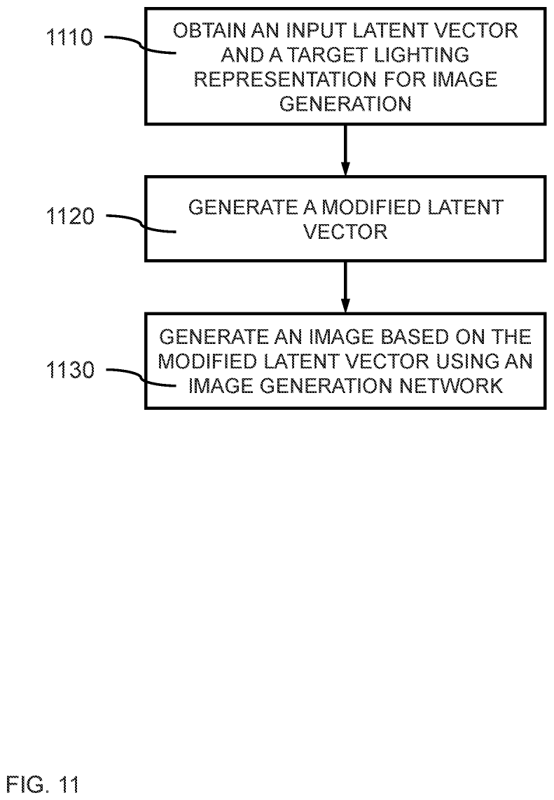

FIG. 11 shows a block diagram of an example of a method of generating a relighted image, according to aspects of the present disclosure.

At operation 1110, an input latent vector and a target lighting representation can be obtained for an image generation network. The input latent vector can represent an original image, and the target lighting representation can represent different lighting features to be applied to the original image. The original lighting features of the original image can be embedded in the input latent vector. The target lighting representation can be a vector including the coefficients of a spherical harmonic solution.

At operation 1120, a modified latent vector can be generated from the input latent vector and a target lighting representation, where the modified latent vector may be generated by a trained latent mapper. The computations may be performed on the latent vector, which allows for fast inference, as this light-weight network does not require image-level operations for each lighting condition.

At operation 1130, a new relighted image can be generated based on the modified latent vector using an image generation network, where the image generation network can be a pre-trained network.

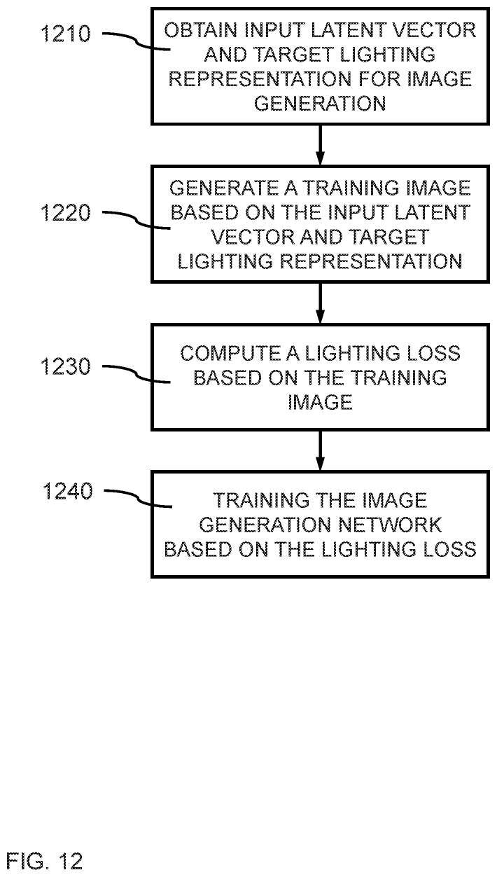

FIG. 12 shows a block diagram of an example of a method of training a relighting model, according to aspects of the present disclosure.

At operation 1210, an input latent vector and target lighting representation can be obtained for image generation. The input latent vector can be obtained using an encoder to encode an original image having original lighting features. The target lighting representation can be a vector including a set of coefficients for spherical harmonics (SH) or SH offsets.

At operation 1220, a training image can be generated based on the input latent vector and the target lighting representation. The training image can be generated by an image generation network (e.g., GAN, StyleGAN, etc.), that outputs a new image with changed lighting based on the target lighting representation. The latent mapper can learn to produce a new latent vector, Wₚ′, 440, which generate images with the correct lighting, where the lighting corresponding to the input SH coefficients.

In various embodiments, the training data set can utilize real images that have not been synthetically generated. The training data set can include about 500,000 real images, that are unlabeled. In various embodiments, the training data set does not use light-stage data with various camera poses.

At operation 1230, a lighting loss can be calculated based on the training image, where the lighting loss can be a SH prediction loss, which regresses the ground-truth lighting representation, and/or a SH consistency loss that allows an image to be relighted without having paired or “ground-truth” images to train with. The latent mapper can be trained using the SH consistency loss for lighting or other image conditions, when a differentiable feature estimator is available for the given condition. The SH prediction loss can ensure that the network can predict the lighting for a given image.

In various embodiments, a relighting network model that works on the StyleGAN latent space can be trained. The image encoder and StyleGAN can be pre-trained networks which are fixed.

In various embodiments, a latent regularization loss can be calculated.

In various embodiments, a consistency loss can be calculated. The consistency losses also allow the method to be applicable to other image domains, where a pre-trained lighting estimator exists.

At operation 1240, an image generation network can be trained based on the calculated lighting loss, where the weights of the image generation network can be updated to reduce the calculated lighting loss. The latent mapper can be trained based on the calculated lighting loss to generate new latent vector, Wₚ′.

In various embodiments, the latent mapper learns to map the latent representation and lighting representation to a new latent representation.

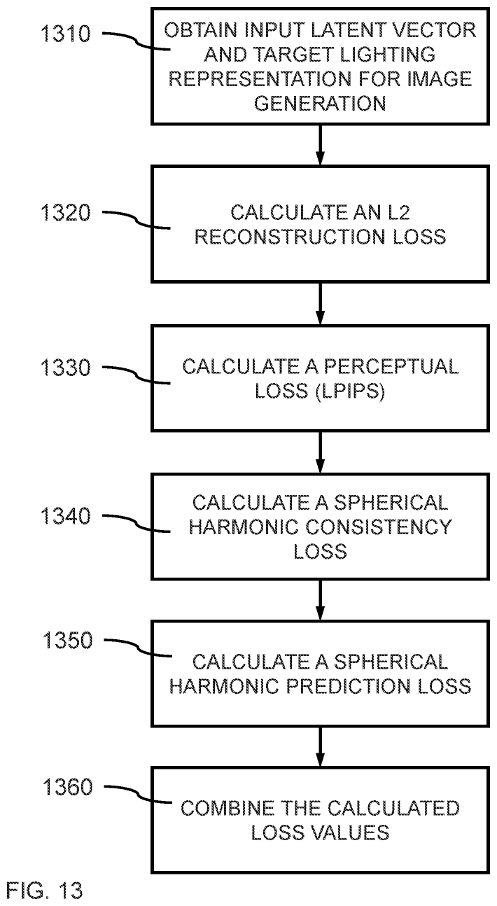

FIG. 13 shows a block diagram of an example of a method of calculating a combination of losses for training, according to aspects of the present disclosure.

At operation 1310, a set of training images and a corresponding set of target lighting representation can be obtained.

At operation 1320, an L2 Reconstruction Loss can be calculated, where the L2 Reconstruction Loss can be calculated for a specific input latent vector, Wₚ, 420. For the specific input latent vector, Wₚ, 420, the original SH coefficients can be extracted from the original image. The input latent vector, Wₚ, 420 and new, different SH coefficients 435 can be passed through the latent mapper to generate a new latent vector, Wₚ′, 440. The new latent vector, Wₚ′, 440 should generate a new image with different lighting features. For calculating this loss, the calculation is minimizing the following:

$${L}_{r e c o n} = {( G ( {W}_{P} ) - G ( {W}_{p}^{′} ) )}^{2} ;$$

where G(·) is the GAN network which generates an image when given a WP vector. L_{recon} is a reconstruction loss.

At operation 1330, a perceptual loss (e.g., LPIPS) can be calculated, where the perceptual loss can be calculated for both the input latent vector, Wₚ, and new SH coefficients. For calculating this loss, the calculation is minimizing the following:

$${L}_{LPIPS} = {( F ( G ( {W}_{P} ) ) - F ( G ( {W}_{p}^{′} ) ) )}^{2} ;$$

where G(·) is the GAN network, which generates an image when given a WP vector. F is a pretrained deep network (e.g., VGG-16), which outputs a feature vector representing the input image.

In various embodiments, a latent L1 regularization can be calculated to ensure the input and output latent vectors, W_{P}, of the mapper are similar.

$${L}_{r e g} = \vert {W}_{P} - {W}_{p}^{′} \vert .$$

At operation 1340, a spherical harmonic (SH) consistency loss can be calculated, where the spherical harmonic (SH) consistency loss can be calculated to minimize the difference between the input SH coefficients and the output SH coefficients generated by DECA. DECA is a pretrained neural network lighting estimator. When provided with an image, DECA can predict the 27 SH coefficients directly. Therefore, for an image generated this manner, the SH coefficients can be estimated using DECA.

$$S {H}_{g e n} = DECA ( G ( {W}_{p}^{′} ) ) ;$$

where Wₚ′ is the latent vector produced by the latent mapper 430, when given the input latent vector, Wₚ, and the target lighting coefficients SHᵢₙₚᵤₜ. The loss is computed by minimizing the equation L_{con}=|SH_{gen}−SHᵢₙₚᵤₜ|. By minimizing this loss, it forces the network to produce images, that have similar lighting, which corresponds to the input target lighting.

At operation 1350, a spherical harmonic prediction loss can be calculated, where the spherical harmonic prediction loss can be calculated to ensure that the network can predict the lighting for a given image.

The latent mapper 430 can output both a latent vector Wₚ′ and a spherical harmonic prediction SH_{pred}, when given an input latent Wₚ and the target lighting coefficients SHᵢₙₚᵤₜ: Wₚ′, SH_{pred}=Mapper(Wₚ, SHᵢₙₚᵤₜ). The predicted spherical harmonic coefficients should correspond to the lighting of the input image regardless of the input/target lighting coefficients. To accomplish this, the loss, L_{pred}=|SH_{pred}−SHᵢₙₚᵤₜ|, can be minimized.

In various embodiments, the spherical harmonic prediction loss also allows for more stable training, where the training converges in a smoother manner, and where the loss is less sporadic, so it produces slightly better results.

At operation 1360, a combined loss value, Lₜₒₜₐₗ, can be calculated from the individual loss values, where the loss formula can be computed as a weighted sum of the above losses:

$${L}_{total} = {λ}_{1} {L}_{recon} + {λ}_{2} {L}_{LPIPS} + {λ}_{3} {L}_{reg} + {λ}_{4} {L}_{c o n} + {λ}_{5} {L}_{pred} ;$$

where all λᵢ are weight hyper-parameters, which are selected empirically.

The sum of the losses, Lₜₒₜₐₗ, can be used for training the latent mapper.

FIG. 14 shows an example of a computing device for a relighting system, according to aspects of the present disclosure.

In various embodiments, the computing device 1400 includes processor(s) 1410, memory subsystem 1420, communication interface 1430, I/O interface 1440, user interface component(s) 1450, and channel 1460.

In various embodiments, computing device 1400 is an example of, or includes aspects of relighting system 120. In some embodiments, computing device 1400 includes one or more processors 1410 that can execute instructions stored in memory subsystem 1420.

In various embodiments, computing device 1400 includes one or more processors 1010. In various embodiments, a processor 1410 can be an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor 1410 is configured to operate a memory array using a memory controller. In other cases, a memory controller is integrated into a processor. In some cases, a processor is configured to execute computer-readable instructions stored in a memory to perform various functions. In some embodiments, a processor 1410 includes special-purpose components for modem processing, baseband processing, digital signal processing, or transmission processing.

A processor 1410 may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor 1410, the functions may be stored in the form of instructions or code on a computer-readable medium.

In various embodiments, memory subsystem 1420 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor 1410 to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1430 operates at a boundary between communicating entities (such as computing device 1400, one or more user devices, a cloud, and one or more databases) and channel 1460 (e.g., bus), and can record and process communications. In some cases, communication interface 1430 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1440 is controlled by an I/O controller to manage input and output signals for computing device 1400. In some cases, I/O interface 1440 manages peripherals not integrated into computing device 1400. In some cases, I/O interface 1440 represents a physical connection or a port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a user interface component, including, but not limited to, a modem, a keyboard, a mouse, a touchscreen, or a similar device. In some cases, the I/O controller is implemented as a component of a processor. In some cases, a user interacts with a device via I/O interface 1440 or via hardware components controlled by the I/O controller.

According to some aspects, user interface component(s) 1450 enable a user to interact with computing device 1400. In some cases, user interface component(s) 1450 include an audio device, such as an external speaker system, an external display device such as a display device 390 (e.g., screen), an input device (e.g., a remote-control device interfaced with a user interface directly or through the I/O controller), or a combination thereof. In some cases, user interface component(s) 1450 include a GUI.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

In this disclosure and the following claims, the word “or” indicates an inclusive list such that, for example, the list of X, Y, or Z means X or Y or Z or XY or XZ or YZ or XYZ. Also, the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input latent vector for an image generation network and a target lighting representation;
generating a modified latent vector based on the input latent vector and the target lighting representation; and
generating an image based on the modified latent vector using an image generation network.

2. The method of claim 1, wherein:
the image depicts an object that is lit according to the target lighting representation.

3. The method of claim 1, wherein:
the target lighting representation comprises a vector in a lighting representation space.

4. The method of claim 3, wherein:
the modified latent vector is generated using a mapping network that is trained by using a lighting loss that compares an output of the image generation network in the lighting representation space.

5. The method of claim 1, wherein:
the target lighting representation indicates a direction and an intensity of a light source.

6. The method of claim 1, further comprising:
generating a random input vector; and
generating the input latent vector based on the random input vector.

7. The method of claim 1, further comprising:
obtaining an additional lighting representation;
generating an additional latent vector based on the input latent vector and the additional lighting representation; and
generating an additional image based on the additional latent vector, wherein the additional image shares an attribute with the image and has different lighting from the image according to the additional lighting representation.

8. A method of training an image generation network, comprising:
obtaining an input latent vector for the image generation network and a target lighting representation;
generating a training image based on the input latent vector and the target lighting representation using the image generation network;
computing a lighting loss based on the training image; and
training the image generation network to generate images with a target lighting based on the lighting loss.

9. The method of claim 8, further comprising:
computing an output lighting representation based on the training image; and
comparing the output lighting representation to the target lighting representation, wherein the lighting loss is based on the comparison of the output lighting representation to the target lighting representation.

10. The method of claim 9, further comprising:
generating a modified latent vector based on the input latent vector and the target lighting representation using a mapping network, wherein the training image is generated based on the modified latent vector, and wherein the mapping network is trained based on the lighting loss.

11. The method of claim 8, further comprising:
generating a comparison image based on the input latent vector;
computing an attribute loss based on the training image and the comparison image, wherein the image generation network is trained based on the attribute loss.

12. The method of claim 8, further comprising:
generating a comparison image based on the input latent vector;
computing a texture loss based on the training image and the comparison image, wherein the image generation network is trained based on the texture loss.

13. The method of claim 8, further comprising:
generating a comparison image based on the input latent vector;
computing an expression loss based on the training image and the comparison image, wherein the image generation network is trained based on the expression loss.

14. The method of claim 8, further comprising:
generating a comparison image based on the input latent vector;
computing a consistency loss based on the training image and the comparison image, wherein the image generation network is trained based on the consistency loss.

15. The method of claim 8, further comprising:
computing a discriminator loss using a discriminator network, wherein the image generation network is trained based on the discriminator loss.

16. An apparatus comprising:
one or more processors;
one or more memories including instructions executable by the one or more processors;
an image generation network comprising parameters stored in the one or more memories, wherein the image generation network takes a target lighting representation as input and is trained to generate images based on the target lighting representation using a lighting loss.

17. The apparatus of claim 16, wherein:
the image generation network comprises a generative adversarial network.

18. The apparatus of claim 17, wherein:
the image generation network comprises a mapping network configured to generate a modified latent vector based on an input latent vector and the target lighting representation.

19. The apparatus of claim 18, wherein:
the mapping network comprises one or more fully connected layers with ReLU activation.

20. The apparatus of claim 19, further comprising:
a training component comprising a lighting estimator configured to generate an estimated lighting representation of an output image, wherein the lighting loss is based on the estimated lighting representation.
